(19) United States
(12) Patent Application Publication
(10) Pub. No.: US 2026/0097852 A1
(43) Pub. Date: Apr. 9, 2026

(54) BLENDED WING AIRCRAFT

(71) Applicant: General Electric Company, Evendale, OH (US)

(72) Inventors: Brandon Wayne Miller, Middletown, OH (US); Arthur William Sibbach, Boxford, MA (US); Nicholas Joseph Kray, Mason, OH (US); Daniel Alan Niergarth, Norwood, OH (US)

(21) Appl. No.: 18/909,209

(22) Filed: Oct. 8, 2024

(51) Int. Cl. B64D 15/04; B64C 39/10; B64D 27/14

(52) U.S. Cl. CPC B64D 15/04; B64C 39/10; B64D 27/14; B64C 2039/105; B64D 2221/00

(57) ABSTRACT

A blended wing aircraft is provided defining a longitudinal direction, a lateral direction, and a longitudinal centerline extending along the longitudinal direction, the blended wing aircraft comprising: a body defining a leading portion; a pair of wings extending outward from the body along the lateral direction, each wing of the pair of wings defining a leading edge; and an icing management system comprising a distribution module and a plurality of icing management modules in thermal communication with the leading portion of the body, the leading edges of the pair of wings, or both, the distribution module in selective communication with each of the plurality of icing management modules to alternatingly activate the plurality of icing management modules.

### FIELD

The present disclosure relates to a blended wing aircraft.

### BACKGROUND

Traditional aircraft designs include a fuselage and a pair of wings. The fuselage is a central body of the aircraft that holds passengers, cargo, equipment, and the like. The wings are attached to the fuselage and are the primary lift-generating surfaces, particularly during constant-altitude flight operations. The aircraft can include engines mounted to the wings to generate thrust for the aircraft, and a tail assembly having a vertical stabilizer and a horizontal stabilizer for vector control. While such an aircraft design is a well-established and proven design, improvements to allow for increased efficiency and cargo utilization would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an aircraft in accordance with an exemplary aspect of the present disclosure.

FIG. 2 is a top, schematic view of an aircraft including an icing management system in accordance with an exemplary aspect of the present disclosure. FIG. 2 shows schematically the connection between the distribution module and the plurality of icing management modules.

FIG. 3 is a schematic, cross-sectional view of a first engine of a propulsion system of the aircraft of FIG. 2 in accordance with an exemplary embodiment of the present disclosure. FIG. 2 shows the first engine being the air or power source for the icing management module, and in particular shows a compressor section of the first engine being a hot air source for the icing management module. In such a manner, it will be appreciated that the icing management system of FIGS. 2 and 3 is a pneumatic icing management system for this embodiment.

FIG. 4 is a schematic view of the icing management system of FIGS. 2 and 3. In particular, FIG. 4 provides a detailed view of the distribution module of the icing management system in embodiments where the di-icing system is a pneumatic system (with the air or power source being the compressor section of the first engine, as shown in FIG. 3). FIG. 4 further shows how a controller can be used to operate the icing management system (the controller being either a stand-alone controller or a controller of the aircraft).

FIG. 5 is a schematic, cross-sectional view of a first engine of a propulsion system of the aircraft of FIG. 2 in accordance with another exemplary embodiment of the present disclosure. FIG. 2 shows the first engine being the air or power source for the icing management module, and in particular shows an electric machine of the first engine being a power source for the icing management module. In such a manner, it will be appreciated that the icing management system of FIG. 5 is an electric icing management system for this embodiment. The engine of FIG. 5 is otherwise configured in the same manner as the engine of FIG. 3.

FIG. 6 is a schematic view of the icing management system of FIGS. 2 and 5. In particular, FIG. 6 provides a detailed view of the distribution module of the icing management system in embodiments where the di-icing system is an electric system (with the air or power source being the electric machine of the first engine, as shown in FIG. 5). FIG. 6 further shows how a controller can be used to operate the icing management system (the controller being either a stand-alone controller or a controller of the aircraft). The system of FIG. 6 is otherwise configured in the same manner as the system of FIG. 4.

FIG. 7 is a close-up, side, schematic view of an aft end of an aircraft having a first engine in accordance with another exemplary embodiment. FIG. 6 more specifically shows the first engine being mounted to a top side of a body of the aircraft, with a flowpath surface of the body defining an inlet channel and including a deflection bump upstream of the inlet channel. The first engine of FIG. 7 may be configured in a similar manner as one or more of the first engines described above with reference to FIG. 3 or 5.

FIG. 8 is a close-up, side, schematic view of the embodiment of FIG. 7. FIG. 8 shows the various measurements to show the relative sizes of the deflection bump, inlet channel, engine inlet diameter, and engine inlet height.

FIG. 9 is a top side view of the exemplary aircraft and first engine of FIGS. 7 and 8. FIG. 9 shows the relative sizes of the deflection bump and the inlet channel in a lateral direction.

FIG. 10 is a flow diagram of a method for operating an icing management system in accordance with an exemplary aspect of the present disclosure. The method of FIG. 10 can be used to control one or more of the exemplary icing management systems described above with reference to FIGS. 1 through 9. The flow diagram shows how the icing management system can be used to cycle through the various segments of the icing management modules to de-ice a large amount of surface area without overloading the air or power source. The activation of the various segments may include opening and/or closing valves (for a pneumatic system), opening and/or closing switches (for an electric system), or the like using a controller.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “forward” and “aft” refer to relative positions within a gas turbine engine or vehicle, and are based on a normal operational attitude of the gas turbine engine or vehicle. More particularly, forward and aft are used herein are with reference to a direction of travel and a direction of propulsive thrust of the gas turbine engine or vehicle.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

As noted above, improvements to traditional aircraft design to allow for increased efficiency and cargo utilization would be welcomed in the art. The inventors of the present disclosure found that utilization of a blended wing aircraft design can provide such an improvement. In particular, with the blended wing aircraft design, a body of the aircraft can contribute to lift, while also allowing for increased cargo space, improved aerodynamic efficiency, etc.

With the blended wing aircraft design, engines of the aircraft can be mounted on a top side of the body, allowing for the body to block at least a portion of the noise from the engines from impacting community locations. Notably, however, as the body of the blended wing aircraft is generating lift during, e.g., constant altitude flight, and since the engines may be mounted at a location downstream from one or more leading edge portions of the body, ice buildup and ice ingestion can be an issue. In order to reduce the risk of ice buildup and ice ingestion, the present disclosure provides for an icing management system for the leading edge portion of the body, for the leading edges of the wings, or both. In particular, the icing management system is operable at least with the leading edge portion of the body at locations upstream of the engines to provide ice management of these surfaces (i.e., de-icing, anti-icing, or a combination thereof).

As will further be appreciated, with the blended wing aircraft design, a surface area of the body at the leading edge portion is greater than with traditional aircraft design. In order to reduce a load on the icing management system, and in particular a hot air source or electric power source for the icing management system (which can be one or more of the engines), the icing management system is configured with a plurality of icing management modules and a distribution module, the distribution module in selective communication with each of the plurality of icing management modules to alternatingly activate the plurality of icing management modules. In such a manner, the icing management module may effectively provide de-icing (or anti-icing) for the aircraft without overly burdening the hot air source or electric power source for the icing management system.

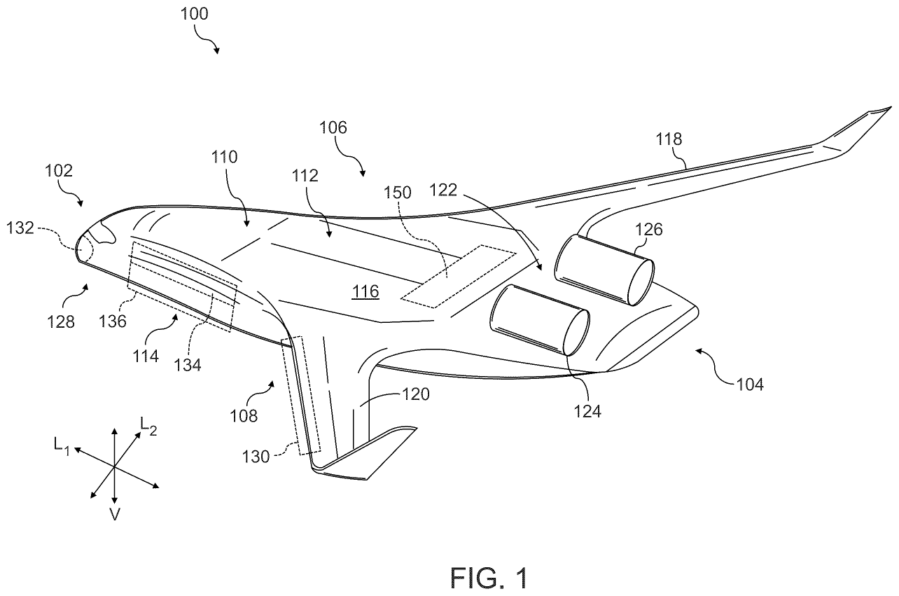

Referring now to the drawings, wherein identical numerals indicate the same elements throughout the figures, FIG. 1 provides a perspective view of an aircraft 100 as may incorporate various embodiments of the present disclosure. In particular, as will be discussed in greater detail, below, the aircraft 100 of FIG. 1 is configured as a blended wing aircraft.

The aircraft 100 defines a longitudinal direction L₁ that extends therethrough, a lateral direction L₂, a vertical direction V, a forward end 102 and an opposing aft end 16 along the longitudinal direction L₁, a starboard side 106 and an opposing port side 108 along the lateral direction L₂, and a top side 112 and an opposing bottom side 114 along the vertical direction V.

Further, it will be appreciated that the aircraft 100 includes a body 110 extending longitudinally from the forward end 102 of the aircraft 100 to the aft end 104 of the aircraft 100, and a pair of wings. In particular, the aircraft 100 includes a first wing 118 and a second wing 120. The first wing 118 extends outwardly from the body 110 generally along the lateral direction L₂ on the starboard side 106 and the second wing 120 similarly extends outwardly from the body 110 generally along the lateral direction L₂ on the port side 108. Although not depicted, it will be appreciated that each of the wings 118, 120 may include one or more leading edge flaps, one or more trailing edge flaps, or both.

The exemplary aircraft 100 of FIG. 1 also includes a propulsion system 122. The exemplary propulsion system 122 depicted includes a plurality of engines, and more specifically includes a first engine 124 and a second engine 126. In the embodiment depicted, the first engine 124 and the second engine 126 are spaced from one another along the lateral direction L₂, and are mounted to the body 110 of the aircraft 100 at the aft end 104 of the aircraft 100. It will be appreciated, that as used herein, the term “at the aft end 104” refers to a location along the longitudinal direction L₁ closer to the aft end 104 of the aircraft 100 than the forward end 102 of the aircraft 100. Briefly, it will further be appreciated that for the embodiment depicted, the first engine 124 and second engine 126 are mounted to the body 110 of the aircraft 100 on the top side 112 of the aircraft 100.

It will be appreciated, however, that in other exemplary embodiments, the first engine 124 and second engine 126 may be mounted to the body 110, e.g., on a bottom side 114 or at a trailing edge (not labeled). Further, the although the first engine 124 and second engine 126 are coupled to the body 110 in the embodiment shown, in other embodiments, they may be formed integrally with the body 110.

As noted above, the aircraft 100 is configured as a blended wing aircraft. In such a manner, it will be appreciated that the body 110 of the aircraft 100 is generally shaped like an airfoil, such that the body 110 of the aircraft 100 generates upward lift (along the vertical direction V) during steady altitude flight operations. For example, during a cruise operating condition of the aircraft 100, the body 110 may contribute between 10% and 95% of the upward lift for the aircraft 100, such as between 25% and 90% of the upward lift for the aircraft 100, with the remainder being provided by the first and second wings 118, 120. In addition, the first and second wings 118, 120 are aerodynamically contoured to have a smooth transition with the body 110 of the aircraft 100, which can reduce an overall drag on the aircraft 100.

Referring still to FIG. 1, it will be appreciated that the body 110 defines a leading portion 128 and the wings 118, 120 each defines a leading edge 130. The leading portion 128 of the body 110 more specifically includes a nose 132 at the forward end 102, an upper leading edge 134 along the sides (extending away from the nose 132 and to the wings 118, 120), and a lower leading edge 136 along the sides (extending away from the nose 132 and to the wings 118, 120). The upper leading edge 134 is above the lower leading edge 136 along the vertical direction V.

One or more areas of the leading portion 128 of the body 110 and leading edges 130 of the wings 118, 120 may be susceptible to ice formation, particularly given the aerodynamic design for these areas to generate lift. Accordingly, the exemplary aircraft 100 of FIG. 1 further includes an icing management system 150 operable with the leading portion 128 of the body 110, the leading edges 130 of the wings 118, 120, or both. The icing management system 150 may provide de-icing for the aircraft 100 at these locations.

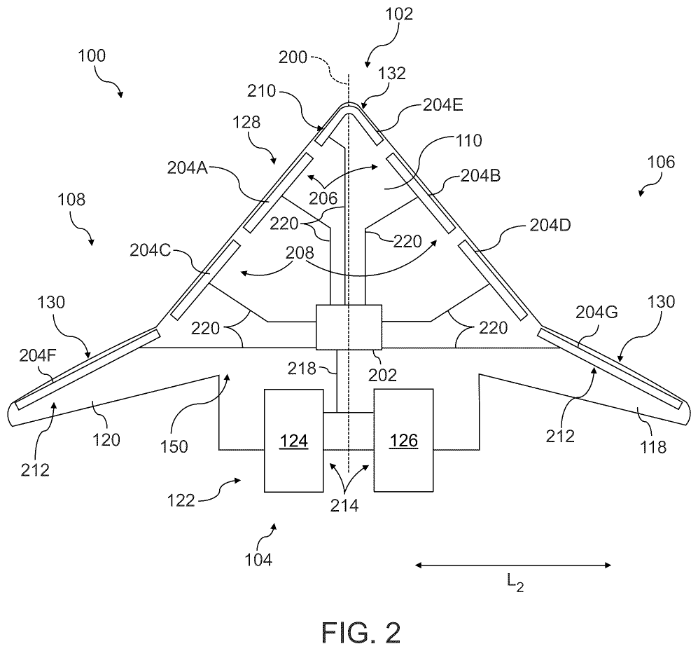

Referring now to FIG. 2, a top, schematic view of the aircraft 100 of FIG. 1 is provided, including the icing management system 150 in accordance with an exemplary aspect of the present disclosure. The aircraft 100 defines the longitudinal direction L₁, the lateral direction L₂, and a longitudinal centerline 200 extending along the longitudinal direction L₁. The icing management system 150 includes a distribution module 202 and a plurality of icing management modules 204 in thermal communication with the leading portion 128 of the body 110, the leading edges 130 of the pair of wings 118, 120, or both. The distribution module 202 is in selective communication with each of the plurality of icing management modules 204 to alternatingly activate the plurality of icing management modules 204.

The plurality of icing management modules 204 are spaced along the lateral direction L₂ and include a first segment of icing management modules 206, a second segment of icing management modules 208, a third segment of icing management modules 210, and a fourth segment of icing management modules 212. The first segment of icing management modules 206 includes a first icing management module 204A on the port side 108 and a second icing management module 204B on the starboard side 106. The second segment of icing management modules 208 includes a third icing management module 204C on the port side 108 and a fourth icing management module 204D on the starboard side 106. The third segment of icing management modules 210 includes a fifth icing management module 204E which is centrally located along the longitudinal centerline 200, and the fourth segment of icing management modules 212 includes a sixth icing management module 204F on the port side 108 and a seventh icing management module 204G on the starboard side 106.

Accordingly, it will be appreciated that in certain exemplary aspects, the icing management modules 206 of a given segment may be positioned on opposite sides of the aircraft 100 (e.g., one on the port side 108 and one on the starboard side 106). Further, in certain exemplary embodiment, the icing management modules 206 of a given segment may be positioned on opposite sides of the aircraft 100 and equally spaced from the longitudinal centerline 200. For example, with respect to the first segment of icing management modules 206, the first icing management module 204A is positioned on the port side 108 and the second icing management module 204B is positioned on the starboard side 106, with the first icing management module 204A and the second icing management module 204B spaced an equal distance along the lateral direction L₂ from the longitudinal centerline 200.

The icing management system 150 further includes an inflow delivery line 218 to the distribution module 202 and a plurality of outflow delivery lines 220 from the distribution module. The distribution module is connected to an air or power source 214 of the aircraft 100 through the 202 inflow delivery line 218, and each of the icing management modules 204A-G is connected to the distribution module 202 by a respective one of the outflow delivery lines 220. The outflow delivery lines 220 allow for the selective activation of the icing management modules 204A-G by the distribution module 202, which can alternatingly direct thermal energy to the different segments of icing management modules 206, 208, 210, and 212. This selective activation is advantageous in managing the power or airflow requirements of the icing management system 150, ensuring that the icing management system 150 can effectively de-ice the aircraft 100 without overloading the air or power source 214 for the icing management system 150.

The air or power source 214 for the icing management system 150 is depicted as the first engine 124 of the propulsion system 122, which can provide hot air or electric power to the distribution module 202 via the inflow delivery line 218. The second engine 126 of the propulsion system 122 is also depicted, and it is understood that either or both engines 124, 126 can serve as the air or power source 214 for the icing management system 150.

The icing management system 150 can be a pneumatic system, wherein the distribution module 202 is in airflow communication with the air or power source 214, and is further in selective airflow communication with each of the plurality of icing management modules 204A-G. With this configuration, it will be appreciated that each of the icing management modules 204 may include a heat exchanger to transfer heat from a fluid through the icing management system 150 and respective icing management module 204 to a surface for the purpose of melting or preventing the formation of ice. The heat exchanger may be a dedicated structure (such as a coil in thermal communication with the surface, an independent fluid loop, or the like), or may simply be the fluid conduit positioned in thermal communication with the surface.

Alternatively, the icing management system 150 can be an electric system, wherein the distribution module 202 is in electrical communication with the air or power source 214, and is further in selective electric communication with each of the plurality of icing management modules 204A-G. With this configuration, it will be appreciated that each of the icing management modules 204 may include an electrically-powered heat source in thermal communication with a surface for the purpose of melting or preventing the formation of ice on the surface. The electrically-powered heat source may be an electric resistance heater, or the like.

The present disclosure provides for a method of operating the icing management system 150 for the blended wing aircraft 100, wherein the distribution module 202 is operated to activate one segment (e.g., the first segment 206) of icing management modules 206, subsequently to activate another segment (e.g., the second segment 208) of icing management modules 208, and so on through all segments of the icing management system 150. This method ensures that the icing management system 150 can effectively de-ice a large surface area of the aircraft 100 without overloading the air or power source 214.

The configuration of the icing management system 150 as shown in FIG. 2 is exemplary and non-limiting. The number of icing management modules 204A-G and their respective segments 206, 208, 210, 212 can be varied to suit different aircraft sizes and de-icing requirements. The distribution module 202 and the icing management modules 204A-G can be designed to accommodate varying thermal communication needs, airflow rates, and electrical power levels, providing flexibility in the design and operation of the icing management system 150 for the blended wing aircraft 100.

Moreover, it will be appreciated that in certain exemplary embodiments the icing management system 150 and icing management modules 204A-G may be configured to provide de-icing for the aircraft 100 (e.g., remove ice buildup). Such a configuration generally requires less hot air flow to the respective surfaces.

However, it will be appreciated that in other exemplary embodiments the icing management system 150 and icing management modules 204A-G may be configured to provide anti-icing for the aircraft 100 (e.g., prevent ice buildup). Such a configuration generally requires more hot air flow to the respective surfaces. With such a configuration, the icing management system 150 and icing management modules 204A-G may provide anti-icing for all the noted surfaces of the aircraft 100, or may provide anti-icing to certain surfaces (e.g., more aerodynamically critical surfaces) and de-icing to the remaining surfaces.

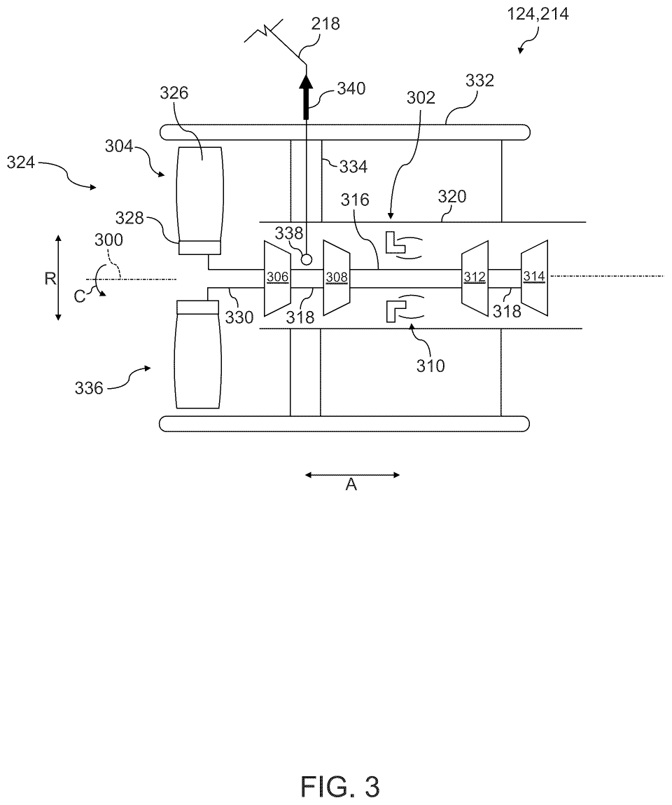

Referring now to FIG. 3, a schematic, cross-sectional view of a first engine 124 of a propulsion system 122 of an aircraft 100 is depicted in accordance with an exemplary embodiment of the present disclosure. The first engine 124 of FIG. 3 may be configured in a similar manner as the exemplary first engine 124 discussed above with reference to FIGS. 1 and 2, and accordingly, the same or similar numbers may refer to the same or similar parts. For example, the first engine 124 may serve as an air or power source 214 for the exemplary icing management system 150 of FIGS. 1 and 2.

The exemplary first engine 124 of FIG. 3 defines an axial direction A, a radial direction R, a circumferential direction C extending about the axial direction A, and a centerline 300 extending along the axial direction A. The first engine 124 includes a turbomachine 302 and a fan assembly 304 driven by the turbomachine 302. The fan assembly 304 includes a fan 324 with fan blades 326 that draw air into the first engine 124. The fan 324 further includes a fan disk 328 and a fan shaft 330. The fan blades 326 are coupled to the disk 328, and the disk 328 is in turn driven by the fan shaft 330.

The turbomachine 302 generally includes a compressor section having a low pressure compressor 306 and a high pressure compressor 308, a combustion section 310, and a turbine section having a high pressure turbine 312 and a low pressure turbine 314. The low pressure compressor 306 and the high pressure compressor 308 function to increase a pressure of air drawn into an inlet of the turbomachine 302. The compressed air is then directed into the combustion section 310, where it is mixed with fuel and ignited to produce high-energy exhaust gases. These gases flow through the high pressure turbine 312 and the low pressure turbine 314, which are connected via a high pressure shaft 318 and a low pressure shaft 320, respectively, to the compressors 306, 308, providing the necessary energy to drive them. The low pressure system (i.e., the low pressure shaft 320, low pressure compressor 306, and low pressure turbine 314) drives the fan shaft 330 and fan 324.

The first engine 124 also includes a turbomachine casing 322, which encloses the components of the turbomachine 302, and an outer nacelle 332, which encloses the fan 324 and at least a portion of the turbomachine 302. The outer nacelle 332 defines an engine inlet 336.

The turbomachine 302 includes a bleed port 338 for extracting airflow from the compressor section. In the embodiment depicted, the bleed port 338 is in airflow communication with an inflow delivery line 218, and a distribution module 202 of an icing management system 150 (see FIG. 2). The bleed port 338 may extract a bleed airflow 340 to be provided through the inflow delivery line 218, such that the first engine 124 serves as a source of thermal energy for ice management operations, preventing ice accumulation on certain surfaces of the aircraft 100.

The first engine 124 is further equipped with guide vanes 334 extending between the turbomachine 302 and outer nacelle 332, which help to direct the airflow efficiently through the engine 124. The inflow delivery line 218 extends through the guide vanes 334 in the embodiment depicted.

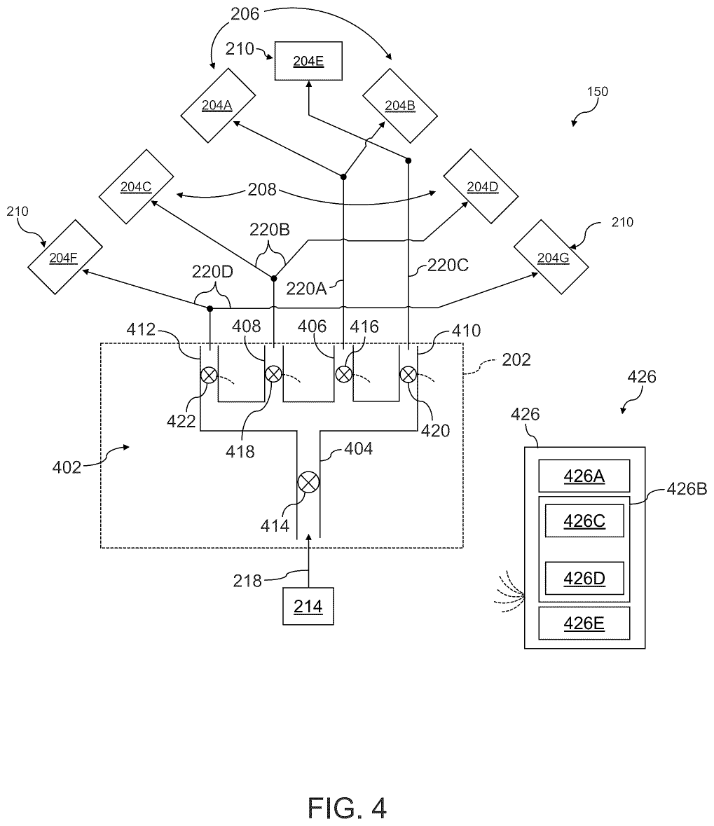

Referring now to FIG. 4, a schematic view of an icing management system 150 of an aircraft 100 is depicted as may be used with the first engine 124 of FIG. 3 as its air or power source 214. The exemplary icing management system 150 of FIG. 4 may be configured in a similar manner as the exemplary icing management system 150 discussed above with reference to FIG. 2, and the same or similar numbers may refer to the same or similar parts.

For example, the icing management system 150 of FIG. 4 includes a distribution module 202 and a plurality of icing management modules 204. In particular, the icing management system 150 includes a first segment 206, a second segment 208, a third segment 210, and a fourth segment 212 of icing management modules 204. For the embodiment depicted, the icing management system 150 is a pneumatic icing management system, utilizing a bleed airflow as a thermal fluid, received from an engine (e.g., a first engine) as the air or power source 214. In such a manner, it will be appreciated that the distribution module 202 is in selective fluid communication with each of the plurality of segments of icing management modules to alternatingly activate the plurality of segments of icing management modules (e.g., segments 206, 208, 210, 212).

The distribution module 202 includes a manifold 402 and the icing management system 150 further includes a controller 424. The manifold 402 includes an inlet duct 404 and a plurality of branches. In particular, for the embodiment depicted, the manifold 402 includes: a first branch 406, a second branch 408, a third branch 410, and a fourth branch 412. Each branch is equipped with a respective airflow valve: a first branch airflow valve 416, a second branch airflow valve 418, a third branch airflow valve 420, and a fourth branch airflow valve 422. These valves are in airflow communication with the respective branch and can be selectively operated to control a flow of ice management air or power to the respective segments of icing management modules 206, 208, 210, and 212.

The inlet duct 404 of the manifold 402 is connected to the air or power source 214 for the icing management system 150 via an inflow delivery line 218 of the icing management system 150. The inlet duct airflow valve 414 is positioned within the inlet duct 404, for the embodiment depicted, to regulate the flow of air (e.g., a bleed airflow) from the source 214 to the distribution module 202.

The icing management modules 204A-G are each connected to their respective branches of the manifold 402 via outflow delivery lines 220A-D of the icing management system 150. These outflow delivery lines 220A-D facilitate the transfer of ice management air in the embodiment show from the distribution module 202 to the icing management modules 204A-G of the first, second third and fourth segments 206, 208, 210, 210. The selective operation of the airflow valves 416, 418, 420, and 422 allows for the targeted activation of the first, second third and fourth segments 206, 208, 210, 210 including the plurality of icing management modules 204, 204A-G, providing an efficient ice management operation by distributing the ice management air as needed, without overloading the air source/power source 214.

The controller 424, which may be a stand-alone controller or integrated into the aircraft's control system, is operatively connected to the distribution module 202. The controller 424 includes a computing device 426 with one or more processors 426A, one or more memory devices 426B, and instructions 426C stored in the one or more memory devices 426B. The computing device 426 also includes data 426D stored in the one or more memory devices 426B and a network interface 426E. The controller 424 is configured to send control signals to the distribution module 202, which in turn operates the various airflow valves 414, 416, 418, 420, and 422 to control the ice management operation.

The manifold 402 and the controller 424 together form a system that can manage the ice management needs of the blended wing aircraft 100. The manifold 402, with its selective valve operation, allows for the distribution module 202 to alternate activation of the segments 206, 208, 210, 210 of icing management modules 204, 204A-G, conserving power or air from the source 214 and ensuring that the aircraft 100 can maintain its performance and safety during icing conditions. The controller 424, with its computing capabilities, can process inputs such as temperature, aircraft speed, and icing conditions to make control decisions to activate the segments 206, 208, 210, 210 of icing management modules 204, 204A-G and execute the necessary control commands to the distribution module 202.

The present disclosure provides for a method of operating the icing management system 150 that includes the steps of operating the distribution module 202 to activate a first segment of icing management modules 206 and subsequently operating the distribution module 202 to activate a second segment of icing management modules 208. This method, facilitated by the manifold 402 and the controller 424, can allow that the icing management system 150 to effectively de-ice the leading portion 128 of the body 110 and the leading edges 130 of the wings 118, 120 (see, e.g., FIGS. 1 and 2) without overloading the air or power source 214 of the icing management system 150.

The configuration of the icing management system 150 as shown in FIG. 4 is exemplary and non-limiting. The manifold 402, its branches 406, 408, 410, 412, and the corresponding airflow valves 416, 418, 420, 422 can be designed to accommodate varying ice management requirements, airflow rates, and power levels, providing flexibility in the design and operation of the icing management system 150 for the blended wing aircraft 100. The controller 424's computing device 426, with its processors 426A, memory devices 426B, and network interface 426E, can be programmed with different operational algorithms and control strategies to optimize the icing management system's performance under various flight conditions.

Further, although the icing management system is shown includes four segments of icing management modules 204, and seven icing management modules 204A-G, correspond to the four branches of the manifold 402, in other embodiments, the icing management system 150 may include any other suitable number of segments (e.g., between two and 20, such as between three and 15) with a corresponding number of branches in the manifold 402, and with any number of icing management modules 204 (e.g., between two and 50, such as between three and 20).

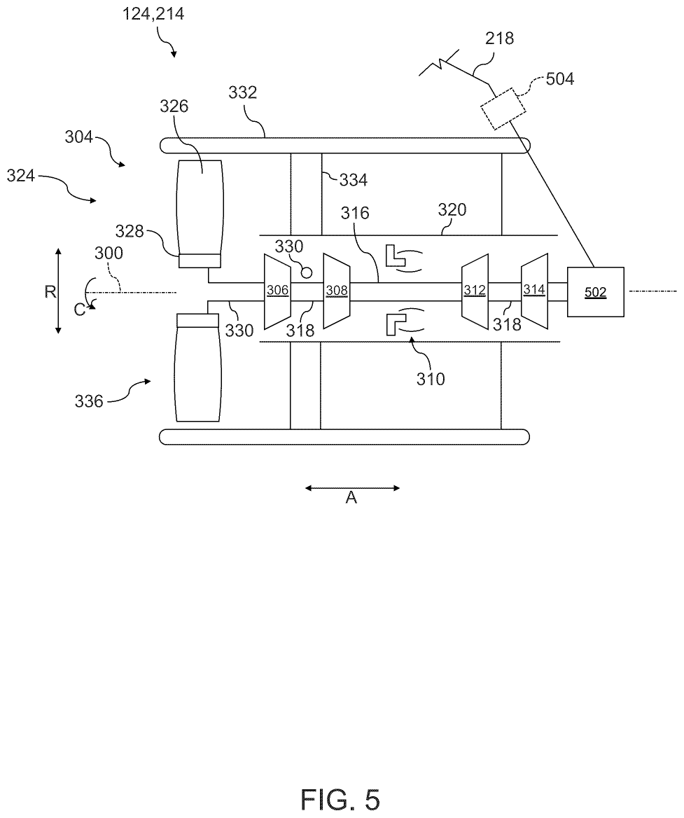

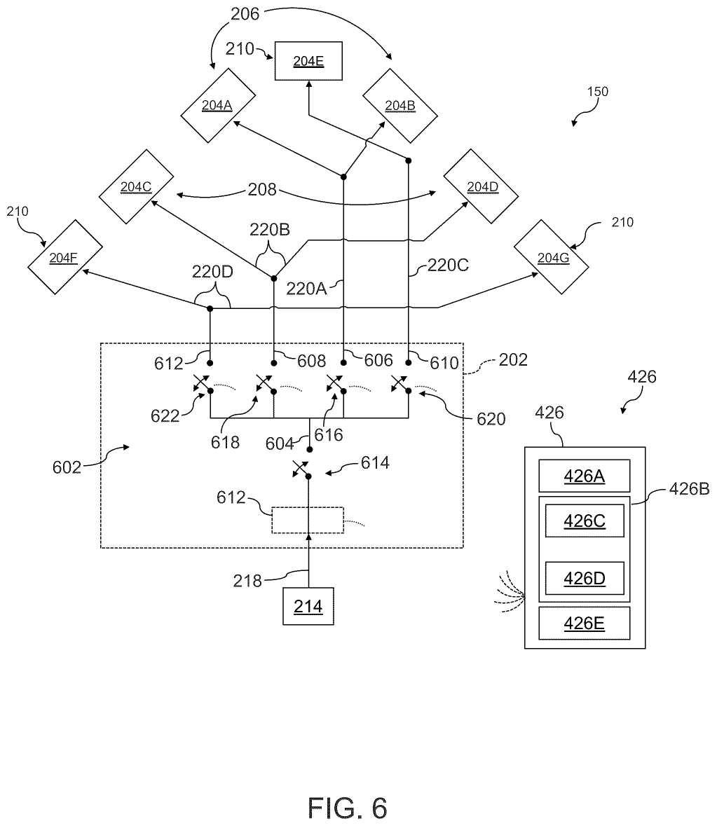

Referring now to FIGS. 5 and 6, it will be appreciated that, as noted above, the icing management system 150 may alternatively be configured as an electric icing management system. With such a configuration, referring particularly to FIG. 5, providing a schematic, cross-sectional view of a first engine 124 of a propulsion system 122 of the aircraft 100 in accordance with another exemplary embodiment of the present disclosure, the air or power source 214 may be an electric system of the propulsion system, such as an electric machine 502 of a first engine 124 of the propulsion system.

For example, the first engine 124 of FIG. 5 may be configured in substantially the same manner as the exemplary first engine 124 of FIG. 3, and the same or similar numbers may refer to the same or similar parts. However, the exemplary first engine of FIG. 5 further includes the electric machine 502 serving as the power source for the icing management module. The electric machine 502 is rotatable with a turbomachine 302 of the first engine 124. The electric machine 502 can provide electrical power to a distribution module 202 of the icing management system 150 (see FIG. 6, discussed in more detail below) via an inflow delivery line 218, which is equipped with power electronics 504. Additionally, the icing management system 150 or first engine 124 can include power electronics 504 to, e.g., regulate electrical power supplied to the distribution module 202 from the electric machine 502.

The configuration of the electric machine 502 and power electronics 504 in FIG. 5 is provided by way of example only, and in other embodiments can be designed in other suitable manners. For example, the electric machine 502 can additionally or alternatively be located at other positions within the first engine 124 and rotatable with other aspects of the first engine 124.

Referring now particularly to FIG. 6, a schematic view of the icing management system 150 of the aircraft 100 is depicted, providing a detailed illustration of the distribution module 202 in embodiments where the icing management system is an electrical system. The icing management system 150 of FIG. 6 may otherwise be configured in substantially the same manner as the exemplary embodiment of FIG. 4, and the same or similar numbers may refer to the same or similar parts.

The exemplary icing management system 150 includes a distribution module 202 and a plurality of icing management modules 204, 204A-G. The distribution module 202 is in electrical communication with the power source 214 through an inflow delivery line 218. More specifically, the power source 214 is an electric power source, which can be a component of the aircraft's propulsion system as discussed above with reference to FIG. 5, and the inflow delivery line 218 is an electric power delivery line (e.g., an electric cable). The distribution module 202 is further in selective electric communication with each of the plurality of icing management modules 204 through a respective plurality of outflow delivery lines 220C, which again are electric power delivery lines. The plurality of icing management modules 204 are configured to be in thermal communication with a leading portion of a body of the aircraft, leading edges of a pair of wings, or both (see FIGS. 1 and 2), when installed in the aircraft. The plurality of icing management modules 204 may be configured as electric resistance heaters, or other suitable heaters for melting ice on the leading portion or leading edges.

The distribution module 202 of FIG. 6 includes an electrical switch box 602. The electrical switch box 602 includes an inlet line 604 and a plurality of outlet lines, each configured as electric power delivery lines. In particular, the plurality of outlet lines includes: a first outlet line 606, a second outlet line 608, a third outlet line 610, and a fourth outlet line 612. Each outlet line is equipped with a respective electrical switch: a first outlet line electrical switch 616, a second outlet line electrical switch 618, a third outlet line electrical switch 620, and a fourth outlet line electrical switch 622. These switches can be selectively operated to control the flow of electric power to the respective segments of icing management modules 206, 208, 210, and 212.

The inlet line 604 of the electrical switch box 602 is connected to the electric power source 214 for the icing management system 150 via the inflow delivery line 218. The inlet line electrical switch 614 is positioned in electric communication with the inlet line 604 to regulate the flow of electric power from the source 214 to the distribution module 202. The distribution module 202 is in selective communication with the first outlet line 606, the second outlet line 608, the third outlet line 610, and the fourth outlet line 612 of the electrical switch box 602, allowing for the alternating activation of the plurality of icing management modules 204A-G connected to each outlet line.

The icing management modules 204A-G are each connected to their respective outlet lines of the electrical switch box 602 via outflow delivery lines 220A-D. These outflow delivery lines 220A-D facilitate the transfer of electric power from the distribution module 202 to the icing management modules 204A-G. The selective operation of the electrical switches 614, 616, 618, 620, and 622 allows for the targeted activation of icing management modules 204A-G, and more specifically, targeted and selective activation of the plurality of segments of icing management modules 206, 208, 210, 212 (which include icing management modules 204A-G), providing an efficient ice management operation by distributing the electric power as needed.

A controller 426, which may be a stand-alone controller or integrated into the aircraft's control system, is operatively connected to the distribution module 202. The controller 426 is configured to send control signals to the distribution module 202, which in turn operates the various electrical switches 614, 616, 618, 620, and 622 to control the ice management operation.

The electrical switch box 602 and the controller 426 together form a system that can effectively manage the ice management needs of the blended wing aircraft 100. The electrical switch box 602, with its selective switch operation, allows for the distribution module 202 to alternate activation of the plurality of segments of icing management modules 206, 208, 210, 212 (including icing management modules 204A-G), conserving electric power from the source 214 and ensuring that the aircraft 100 can maintain its performance and safety during icing conditions. The controller 424, with its computing capabilities, can process inputs such as temperature, aircraft speed, and icing conditions to make control decisions to activate the segments 206, 208, 210, 210 of icing management modules 204, 204A-G and execute the necessary control commands to the distribution module 202.

The present disclosure provides for a method of operating the icing management system 150 that includes the steps of operating the distribution module 202 to activate a first segment of icing management modules 206 and subsequently operating the distribution module 202 to activate a second segment of icing management modules 208. This method, facilitated by the manifold 402 and the controller 424, can allow that the icing management system 150 to effectively de-ice the leading portion 128 of the body 110 and the leading edges 130 of the wings 118, 120 (see, e.g., FIGS. 1 and 2) without overloading the air or power source 214 of the icing management system 150.

The configuration of the icing management system 150 as shown in FIG. 6 is exemplary and non-limiting. The electrical switch box 602, its outlet lines 606, 608, 610, 612, and the corresponding electrical switches 616, 618, 620, 622 can be designed to accommodate varying ice management requirements, power levels, and electrical communication needs, providing flexibility in the design and operation of the icing management system 150 for the blended wing aircraft 100.

Moreover, it will be appreciated that although the exemplary embodiments above show a fully pneumatic icing management system 150 (see, e.g., FIGS. 3 and 4) and a fully electric icing management system 150 (see, e.g., FIGS. 5 and 6), in other exemplary embodiments, the icing management system 150 may be a hybrid /eumatic/ electric icing management system 150 (e.g., having one or more aspects of the icing management system 150 of FIGS. 3 and 4 and one or more aspects of the icing management system 150 of FIGS. 5 and 6).

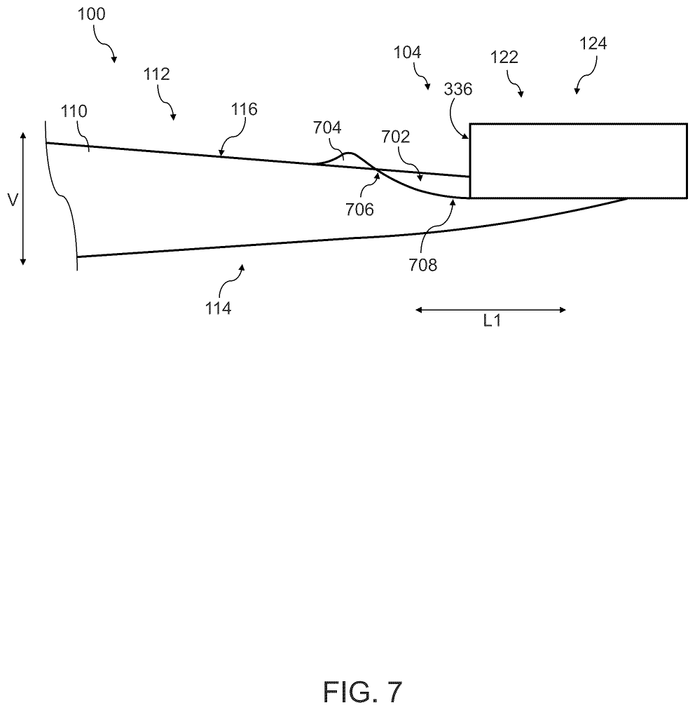

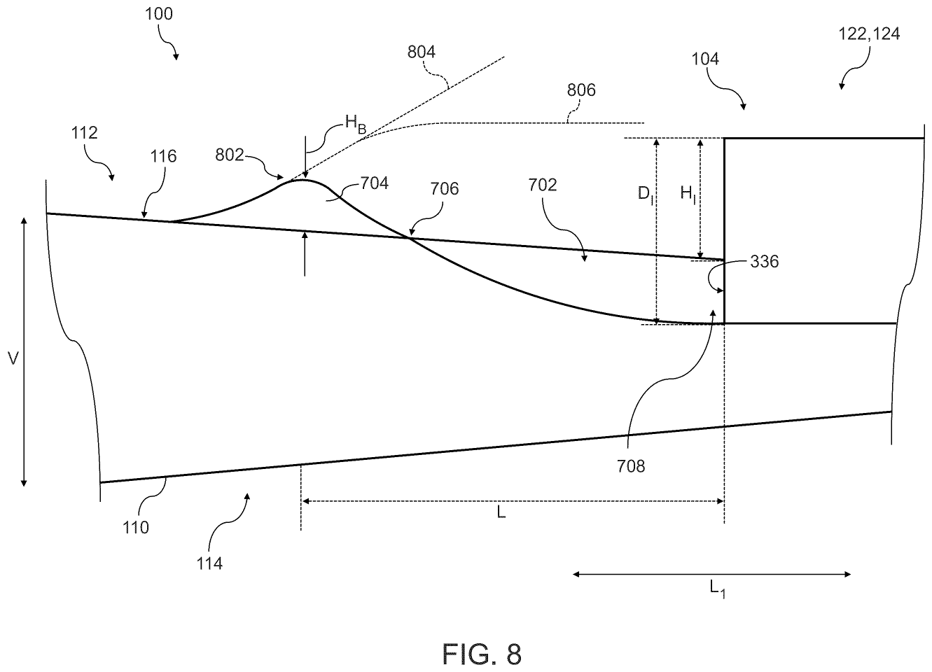

Referring now to FIGS. 7 and 8, a schematic view of an aft end 104 of an aircraft 100 in accordance with an exemplary embodiment of the present disclosure is provided. FIG. 7 provides a schematic view of the aft end 104, and FIG. 8 provides a close-up view of the aft end 104 of FIG. 7. The aircraft 100 of FIGS. 7 and 8 may be configured in similar manner as the exemplary aircraft 100 of FIGS. 1 and 2, and the same or similar numbers may refer to the same or similar parts.

In the embodiment depicted, the aircraft 100 includes a propulsion system 122 having a first engine 124 mounted to a top side 112 of a body 110 of the aircraft 100. The body 110 of the aircraft 100 defines a flowpath surface 116, which in turn defines an inlet channel 702 and includes a deflection bump 704 within the inlet channel 702 or upstream of the inlet channel 702. In particular, for the embodiment of FIG. 7, the deflection bump 704 is located upstream of the inlet channel 702. The inlet channel 702 is structured to guide airflow into the first engine 124, while the deflection bump 704 serves to deflect debris, including ice melted from an upstream surface using an icing management system (e.g., one or more of the icing management systems 150 of FIGS. 1 through 6), away from an engine inlet 336 of the first engine 124.

More specifically, the inlet channel 702 extends from an upstream end 706 to a downstream end 708, and the deflection bump 704 is positioned at the upstream end 706 of the inlet channel 702. The downstream end 708 of the inlet channel 702 is the point where the airflow is directed into the engine inlet 336. The deflection bump 704 and the inlet channel 702 together form an aerodynamic feature designed to provide a desired airflow into the first engine 124 while reducing a risk of foreign object damage by deflecting debris away from the engine inlet 336.

The present disclosure contemplates that the deflection bump 704 can be of various shapes and sizes, tailored to the specific aerodynamic and operational requirements of the aircraft 100.

Referring particularly to FIG. 8, the deflection bump 704 defines an apex 802 and a height H_{B}, with the height H_{B} of the deflection bump 704 being measured in the vertical direction V from the flowpath surface 116 at a location adjacent to the deflection bump 704 (in a lateral direction L₂ (see, e.g., FIG. 1)) to the apex 802. The height H_{B} of the bump 704 influences an effectiveness of the deflection of particulates away from the engine inlet 336. Notably, the engine inlet 336 defines the diameter D_{I} and a height H_{I} (the height H_{I} being defined from a top of the inlet channel 702 to a top of the engine inlet 336 in a vertical direction V. The aircraft 100 further defines a length L from the apex 802 of the bump 704 to the engine inlet 336 along the longitudinal direction L₁, as is indicated, providing a reference for the positioning of the bump 704 relative to the inlet 222.

The relationship between the height H_{B} of the bump 704, the height H_{I} of the engine inlet 336, the inlet diameter D_{I} of the engine inlet 336, and the length L is depicted. These dimensions can determine the aerodynamic properties and the protective capabilities of the deflection bump 704. In particular, in the course of designing an aircraft 100 that effectively deflected particulates from the engine inlet 336, the inventors found a relationship of several of these parameters that can result in a deflection bump 704 that provides a desired deflection of particulates while maintaining a desired flow of air into the engine 124.

More specifically, the inventors found that a deflection bump defining bump height H_{B} greater than or equal to H_{I}/(π×L) and less than or equal to [π×(H_{I}+D_{I})]/L can provide a desired deflection of particulates while maintaining a desired flow of air into the engine 124.

Referring still to FIG. 8, it will be appreciated that the deflection bump 704 further defines a reference trajectory line 804, which is a theoretical trajectory for an object flowing over the deflection bump 704 without the influence of airflow over the aircraft 100. In addition, the deflection bump 704 defines a debris trajectory 806 extending from the deflection bump 704 outward of the engine inlet 336 (along the vertical direction V). The debris trajectory 806 takes into account the influence of airflow over the aircraft 100, and represents a minimal vertical travel for potential ice and debris to bypass an engine inlet 336, and in particular to bypass an inlet to the turbomachine 302 of the first engine 124. As will be appreciated, the deflection bump 704 is configured to deflect objects that may damage components of the first engine 124 outside of the engine inlet 336 in the vertical direction V.

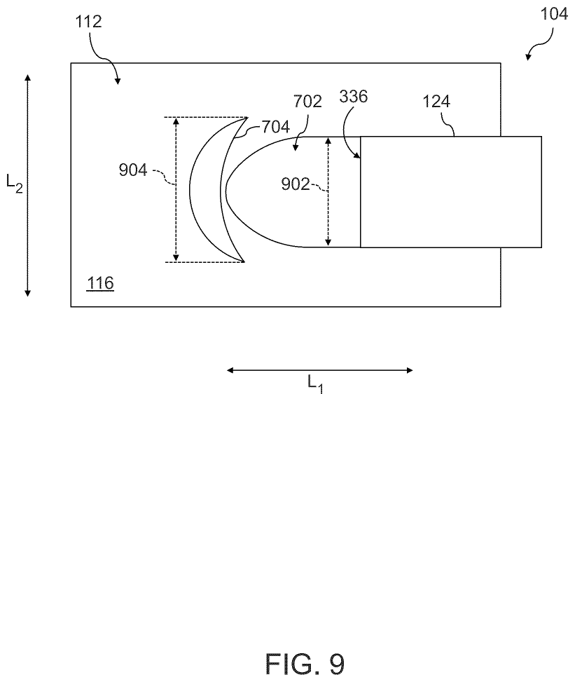

Referring now briefly to FIG. 9, a top side view of the exemplary the aircraft 100 of FIGS. 7 and 8 is depicted. As will be appreciated from this view, the exemplary deflection bump 704 defines a width 904 in the lateral direction L₂. This width 904 is indicative of a size of the deflection bump 704 and its ability to influence the airflow and debris trajectory. The inlet channel 702 similarly defines a width 902 in the lateral direction L₂ at the upstream end 706. The relationship between the width 904 of the deflection bump 704 and the width 902 of the inlet channel 702 at the upstream end 706 influences the effectiveness of debris deflection. In the present embodiment, the width 904 of the deflection bump 704 is greater than the width 902 of the inlet channel 702 at the upstream end 706. This configuration can be advantageous in certain operational scenarios. For instance, the wider deflection bump 704 can provide enhanced protection for the engine 124.

The present disclosure contemplates various embodiments of the deflection bump 704, wherein the dimensions and positioning can be adjusted based on specific aircraft designs and operational requirements. The deflection bump 704 can be provided to deflect a range of particulate sizes and densities, ensuring the protection of the first engine 124 under various environmental conditions, including during icing conditions and during operation of an icing management system in accordance with the present disclosure. Additionally, the deflection bump 704 can be constructed from materials that offer the necessary durability and impact resistance to withstand the forces encountered during flight, which may be different than a material forming a remainder of the body 110.

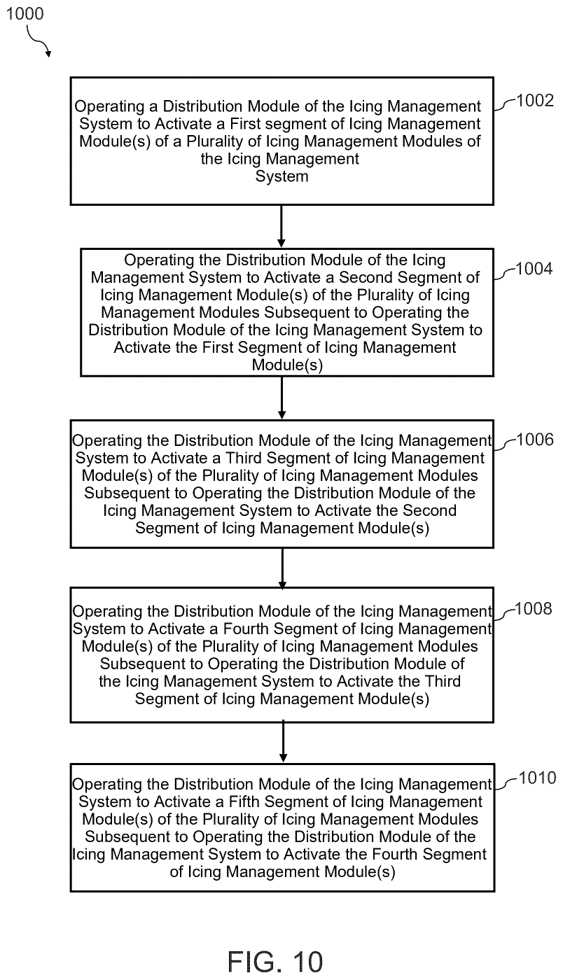

Referring now to FIG. 10, a flow diagram of a method 1000 for operating an icing management system in accordance with an exemplary aspect of the present disclosure is provided. The method 1000 can be implemented to control the icing management system of the blended wing aircraft 100, as previously described with reference to FIGS. 1 through 9. The flow diagram illustrates a sequential operation of the icing management system, which allows for efficient management of thermal energy distribution across various segments of the icing management modules without overburdening the air or power source.

The method 1000 begins with a method step 1002, which involves operating a distribution module of the icing management system to activate a first segment of icing management module(s) of a plurality of icing management modules of the icing management system. The first segment of icing management modules may include, for example, a first icing management module 204A on the port side 108 and a second icing management module 204B on the starboard side 106 of the aircraft 100. This step provides for a first section of a leading portion of a body of the aircraft or leading edges of wings of the aircraft are kept clear of ice, maintaining the aerodynamic efficiency and safety of the aircraft during flight.

Subsequent to method step 1002, method step 1004 is executed, which involves operating the distribution module of the icing management system to activate a second segment of icing management module(s) of the plurality of icing management modules. This activation occurs subsequent to operating the distribution module to activate the first segment of icing management module(s). The second segment of icing management modules may include, for example, a third icing management module 204C on the port side 108 and a fourth icing management module 204D on the starboard side 106. This alternating activation strategy allows for the thermal energy to be distributed effectively across the aircraft's surface while managing the load on the icing management system's air or power source.

Continuing the sequential operation, method step 1006 involves operating the distribution module of the icing management system to activate a third segment of icing management module(s) subsequent to activating the second segment of icing management module(s). This step provides further coverage for ice management (de-icing or anti-icing) operations, ensuring that a desired surface area susceptible to ice formation is addressed, e.g., in a systematic manner.

Method step 1008 follows, wherein the distribution module of the icing management system is operated to activate a fourth segment of icing management module(s) subsequent to the activation of the third segment of icing management module(s). This step continues the pattern of sequential activation, allowing for comprehensive de-icing (or anti-icing) coverage without overloading the icing management system.

Finally, method step 1010 concludes the sequential operation of the icing management system. In this step, the distribution module is operated to activate a fifth segment of icing management module(s) subsequent to the activation of the fourth segment of icing management module(s). This step ensures that all segments of the icing management modules have been activated, providing a complete cycle of de-icing (or anti-icing) that maintains the aircraft's performance and safety.

The method 1000 depicted in FIG. 10 is exemplary of how the icing management system of the blended wing aircraft 100 can be operated in a controlled and efficient manner. The sequential activation of the segments of icing management modules allows for the icing management system to effectively manage the thermal energy distribution, ensuring that the aircraft remains free of ice accumulation during critical phases of flight. This method can be adapted and modified to accommodate different configurations of icing management systems, the number of icing management modules, and the specific operational requirements of various blended wing aircraft designs.

The method 1000 may be executed using a controller of an aircraft and/or icing management system, such as the exemplary controller 426 of FIGS. 4 and 6. Accordingly, in certain exemplary embodiments, “activating a segment of icing management module(s)” may include opening one or more airflow valves associated with the segment of icing management modules and potentially closing one or more airflow valves that are associated with other segment(s) of icing management modules (see, e.g., FIGS. 3 and 4). Additionally, or alternatively, in certain exemplary embodiments, “activating a segment of icing management module(s)” may include making an electrical connection by closing one or more electrical switches associated with the segment of icing management modules and potentially opening one or more electrical switches that are associated with other segment(s) of icing management modules (see, e.g., FIGS. 5 and 6).

In view of the above description and associated figures, it will be appreciated that the disclosed icing management module may effectively provide de-icing (or anti-icing) for the aircraft without overly burdening the hot air source or electric power source for the icing management system. This can result in an overall more efficient aircraft, despite the increased surface area susceptible to icing as a result of the blended wing design.

Further aspects are provided by the subject matter of the following clauses:

A blended wing aircraft defining a longitudinal direction, a lateral direction, and a longitudinal centerline extending along the longitudinal direction, the blended wing aircraft comprising: a body defining a leading portion; a pair of wings extending outward from the body along the lateral direction, each wing of the pair of wings defining a leading edge; and an icing management system comprising a distribution module and a plurality of icing management modules in thermal communication with the leading portion of the body, the leading edges of the pair of wings, or both, the distribution module in selective communication with each of the plurality of icing management modules to alternatingly activate the plurality of icing management modules.

The blended wing aircraft of any preceding clause, wherein the plurality of icing management modules are in thermal communication with the leading portion of the body and the leading edges of the pair of wings.

The blended wing aircraft of any preceding clause, wherein the plurality of icing management modules are spaced along the lateral direction.

The blended wing aircraft of any preceding clause, wherein the plurality of icing management modules includes at least three icing management modules and up to 20 icing management modules.

The blended wing aircraft of any preceding clause, wherein the plurality of icing management modules includes a plurality of segments of icing management modules, wherein the distribution module is in selective fluid communication with each of the plurality of segments of icing management modules to alternatingly activate the plurality of segments of icing management modules.

The blended wing aircraft of any preceding clause, wherein the blended wing aircraft defines a port side and a starboard side, wherein the plurality of icing management modules includes a first icing management module on the port side and a second icing management module on the starboard side, wherein the first icing management module and the second icing management module are spaced an equal distance along the lateral direction from the longitudinal centerline, and wherein the first icing management module and the second icing management module together form a first segment of icing management modules.

The blended wing aircraft of any preceding clause, wherein the icing management system is a pneumatic system, wherein the distribution module is in airflow communication with an air source, and is further in selective airflow communication with each of the plurality of icing management modules.

The blended wing aircraft of any preceding clause, further comprising: a gas turbine engine coupled to, or formed integrally with, the body, wherein the air source for the distribution module is the gas turbine engine.

The blended wing aircraft of any preceding clause, wherein the gas turbine engine comprises a turbomachine comprising a compressor section, wherein the air source for the distribution module is the compressor section of the turbomachine of the gas turbine engine.

The blended wing aircraft of any preceding clause, wherein the icing management system is an electrical system, wherein the distribution module is in electrical communication with an electric power source, and is further in selective electric communication with each of the plurality of icing management modules.

The blended wing aircraft of any preceding clause, further comprising: a gas turbine engine coupled to, or formed integrally with, the body, wherein the electric power source for the distribution module is the gas turbine engine.

The blended wing aircraft of any preceding clause, wherein the gas turbine engine comprises a turbomachine and an electric machine rotatable with the turbomachine, wherein the electric power source for the distribution module is the electric machine.

The blended wing aircraft of any preceding clause, further comprising: an engine coupled to, or formed integrally with, the body, wherein the body defines a flowpath surface, and wherein the flowpath surface defines a deflection bump at a location downstream of one or more of the icing management modules and upstream of the engine.

The blended wing aircraft of any preceding clause, wherein the deflection bump defines a debris trajectory extending from the deflection bump outward of an inlet to the engine.

The blended wing aircraft of any preceding clause, further comprising: a controller operably connected to the distribution module, the controller configured to send control signals to the distribution module to alternatingly activate of the plurality of icing management modules.

An icing management system for a blended wing aircraft, the icing management system comprising: a distribution module; and a plurality of icing management modules, the plurality of icing management modules configured to be in thermal communication with a leading portion of a body of the blended wing aircraft, with leading edges of a pair of wings of the blended wing aircraft, or both when the icing management module is installed in the blended wing aircraft, the distribution module in selective communication with each of the plurality of icing management modules to alternatingly activate the plurality of icing management modules.

The icing management system of any preceding clause, wherein the plurality of icing management modules includes a plurality of segments of icing management modules, wherein the distribution module is in selective fluid communication with each of the plurality of segments of icing management modules to alternatingly activate the plurality of segments of icing management modules.

The icing management system of any preceding clause, wherein the plurality of icing management modules includes a plurality of segments of icing management modules, wherein the blended wing aircraft defines a port side and a starboard side, wherein the plurality of segments of icing management modules includes a first icing management module configured to be positioned on a port side of the blended wing aircraft and a second icing management module configured to be positioned on a starboard side of the blended wing aircraft, wherein the first icing management module and the second icing management module together form a first segment of icing management modules.

The icing management system of any preceding clause, wherein the icing management system is a pneumatic system, wherein the distribution module is in airflow communication with an air source, and is further in selective airflow communication with each of the plurality of icing management modules.

The icing management system of any preceding clause, wherein the icing management system is an electrical system, wherein the distribution module is in electrical communication with an electric power source, and is further in selective electric communication with each of the plurality of icing management modules.

A method of operating an icing management system for a blended wing aircraft, the method comprising: operating a distribution module of the icing management system to activate a first segment of icing management module(s) of a plurality of icing management modules of the icing management system; and operating the distribution module of the icing management system to activate a second segment of icing management module(s) of the plurality of icing management modules subsequent to operating the distribution module of the icing management system to activate the first segment of icing management module(s), wherein each of the plurality of icing management modules is in thermal communication with a leading portion of a body of the aircraft, leading edges of a pair of wings of the aircraft, or both.

The method of any preceding clause, wherein the blended wing aircraft defines a port side and a starboard side, wherein the plurality of icing management modules includes a first icing management module on the port side and a second icing management module on the starboard side, wherein the first icing management module and the second icing management module are each spaced a first distance along the lateral direction from a longitudinal centerline of the blended wing aircraft, and wherein the first segment of icing management module(s) includes at least the first icing management module and the second icing management module.

The method of any preceding clause, wherein the plurality of icing management modules further includes a third icing management module on the port side and a fourth icing management module on the starboard side, wherein the third icing management module and the fourth icing management module are each spaced a second distance along the lateral direction from the longitudinal centerline greater than the first distance, and wherein the second segment of icing management module(s) includes at least the third icing management module and the fourth icing management module.

The blended wing aircraft of any preceding clause, wherein the plurality of icing management modules includes a third icing management module on the port side and a fourth icing management module on the starboard side, wherein the third icing management module and the fourth icing management module are spaced an equal distance along the lateral direction from the longitudinal centerline, and wherein the third icing management module and the fourth icing management module together form a second segment of icing management modules.

The blended wing aircraft of any preceding clause, wherein the first segment of icing management modules and the second segment of icing management modules are both positioned in thermal communication with the leading portion of the body.

The blended wing aircraft of any preceding clause, wherein the leading portion of the body includes a nose, wherein the plurality of icing management modules includes a fifth icing management module in thermal communication with the nose, wherein the fifth icing management module forms a third segment of icing management modules.

The blended wing aircraft of any preceding clause, wherein the plurality of icing management modules includes a sixth icing management module on the port side and a seventh icing management module on the starboard side, wherein the sixth icing management module and the seventh icing management module are spaced an equal distance along the lateral direction from the longitudinal centerline, and wherein the sixth icing management module and the seventh icing management module together form a fourth segment of icing management modules.

The blended wing aircraft of any preceding clause, wherein the sixth icing management module is in the thermal communication the leading edge of a first wing of the pair of wings, and wherein the seventh icing management module is in the thermal communication the leading edge of a second wing of the pair of wings.

The blended wing aircraft of any preceding clause, wherein the body defines a trailing edge and a flowpath surface, wherein the engine is mounted at the trailing edge, and wherein the flowpath surface defines an inlet channel for the engine.

The blended wing aircraft of any preceding clause, wherein the engine is a gas turbine engine comprising an engine inlet, wherein the inlet channel extends to the engine inlet.

The blended wing aircraft of any preceding clause, wherein the deflection bump is located upstream of the inlet channel or positioned within the inlet channel.

The blended wing aircraft of any preceding clause, wherein the deflection bump defines an apex and a bump height (H_{B}) at the apex, wherein engine inlet defines an inlet diameter (D_{I}), and wherein the bump height (H_{B}) is less than the inlet diameter (D_{I}).

The blended wing aircraft of any preceding clause, wherein the blended wing aircraft defines a length (L) from the apex to the engine inlet along the longitudinal direction and an inlet height (H_{I}), wherein the inlet height (H_{I}) is equal the inlet diameter (D_{I}) minus a depth of the inlet channel at a downstream end, and wherein the bump height (H_{B}) is greater than or equal to H_{I}/(π×L) and less than or equal to [π×(H_{I}+D_{I})]/L.

The blended wing aircraft of any preceding clause, wherein the deflection bump is located upstream of the inlet channel.

The blended wing aircraft of any preceding clause, wherein the deflection bump defines a bump width along the lateral direction, wherein the inlet channel defines an upstream end, wherein the upstream end defines an upstream width along the lateral direction, and wherein the bump width is greater than the upstream width.

The blended wing aircraft of any preceding clause, wherein each icing management module of the plurality of icing management modules includes a heat exchanger or an electrically-powered heat source.

The blended wing aircraft of any preceding clause, wherein the heat exchanger is a dedicated structure, such as a coil in thermal communication with a surface, an independent fluid loop, an impingement heating nozzle, or the like, or a portion of a fluid duct transporting a fluid of the icing management system.

The blended wing aircraft of any preceding clause, wherein the electrically-powered heat source is an electric resistance heater.

A controller comprising memory and one or more processors, the memory storing instructions that, when executed by the one or more processors, cause the controller to perform operations, the operations including one or more aspects of a method of any preceding clause.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A blended wing aircraft defining a longitudinal direction, a lateral direction, and a longitudinal centerline extending along the longitudinal direction, the blended wing aircraft comprising:
a body defining a leading portion;
a pair of wings extending outward from the body along the lateral direction, each wing of the pair of wings defining a leading edge; and
an icing management system comprising a distribution module and a plurality of icing management modules in thermal communication with the leading portion of the body, the leading edges of the pair of wings, or both, the distribution module in selective communication with each of the plurality of icing management modules to alternatingly activate independent segments of the plurality of icing management modules.

2. The blended wing aircraft of claim 1, wherein the plurality of icing management modules are in thermal communication with the leading portion of the body and the leading edges of the pair of wings.

3. The blended wing aircraft of claim 1, wherein the plurality of icing management modules are spaced along the lateral direction.

4. The blended wing aircraft of claim 1, wherein the plurality of icing management modules includes at least three icing management modules and up to 20 icing management modules.

5. The blended wing aircraft of claim 1, wherein the plurality of icing management modules includes a plurality of segments of icing management modules, wherein the distribution module is in selective fluid communication with each of the plurality of segments of icing management modules to alternatingly activate the plurality of segments of icing management modules.

6. The blended wing aircraft of claim 5, wherein the blended wing aircraft defines a port side and a starboard side, wherein the plurality of icing management modules includes a first icing management module on the port side and a second icing management module on the starboard side, wherein the first icing management module and the second icing management module are spaced an equal distance along the lateral direction from the longitudinal centerline, and wherein the first icing management module and the second icing management module together form a first segment of icing management modules.

7. The blended wing aircraft of claim 1, wherein the icing management system is a pneumatic system, wherein the distribution module is in airflow communication with an air source, and is further in selective airflow communication with each of the plurality of icing management modules.

8. The blended wing aircraft of claim 7, further comprising:
a gas turbine engine coupled to, or formed integrally with, the body, wherein the air source for the distribution module is the gas turbine engine.

9. The blended wing aircraft of claim 8, wherein the gas turbine engine comprises a turbomachine comprising a compressor section, wherein the air source for the distribution module is the compressor section of the turbomachine of the gas turbine engine.

10. The blended wing aircraft of claim 1, wherein the icing management system is an electrical system, wherein the distribution module is in electrical communication with an electric power source, and is further in selective electric communication with each of the plurality of icing management modules.

11. The blended wing aircraft of claim 10, further comprising:
a gas turbine engine coupled to, or formed integrally with, the body, wherein the electric power source for the distribution module is the gas turbine engine.

12. The blended wing aircraft of claim 11, wherein the gas turbine engine comprises a turbomachine and an electric machine rotatable with the turbomachine, wherein the electric power source for the distribution module is the electric machine.

13. The blended wing aircraft of claim 1, further comprising:
an engine coupled to, or formed integrally with, the body, wherein the body defines a flowpath surface, and wherein the flowpath surface defines a deflection bump at a location downstream of one or more of the icing management modules and upstream of the engine.

14. The blended wing aircraft of claim 1, further comprising:
a controller operably connected to the distribution module, the controller configured to send control signals to the distribution module to alternatingly activate of the plurality of icing management modules.

15. An icing management system for a blended wing aircraft, the blended wing aircraft defining a longitudinal direction, a lateral direction, and a longitudinal centerline extending along the longitudinal direction, the icing management system comprising:
a distribution module; and
a plurality of icing management modules, the plurality of icing management modules configured to be in thermal communication with a leading portion of a body of the blended wing aircraft, with leading edges of a pair of wings of the blended wing aircraft, or both when the icing management module is installed in the blended wing aircraft, the distribution module in selective communication with each of the plurality of icing management modules to alternatingly activate independent segments of the plurality of icing management modules.

16. The icing management system of claim 15, wherein the plurality of icing management modules includes a plurality of segments of icing management modules, wherein the distribution module is in selective fluid communication with each of the plurality of segments of icing management modules to alternatingly activate the plurality of segments of icing management modules.

17. The icing management system of claim 15, wherein the plurality of icing management modules includes a plurality of segments of icing management modules, wherein the blended wing aircraft defines a port side and a starboard side, wherein the plurality of segments of icing management modules includes a first icing management module configured to be positioned on the port side of the blended wing aircraft and a second icing management module configured to be positioned on the starboard side of the blended wing aircraft, wherein the first icing management module and the second icing management module together form a first segment of icing management modules.

18. A method of operating an icing management system for a blended wing aircraft, the method comprising:
operating a distribution module of the icing management system to activate a first segment of icing management module(s) of a plurality of icing management modules of the icing management system; and
operating the distribution module of the icing management system to activate a second segment of icing management module(s) of the plurality of icing management modules subsequent to operating the distribution module of the icing management system to activate the first segment of icing management module(s), wherein each of the plurality of icing management modules is in thermal communication with a leading portion of a body of the aircraft, leading edges of a pair of wings of the aircraft, or both.

19. The method of claim 18, wherein the blended wing aircraft defines a port side and a starboard side, wherein the plurality of icing management modules includes a first icing management module on the port side and a second icing management module on the starboard side, wherein the first icing management module and the second icing management module are each spaced a first distance along the lateral direction from a longitudinal centerline of the blended wing aircraft, and wherein the first segment of icing management module(s) includes at least the first icing management module and the second icing management module.

20. The method of claim 19, wherein the plurality of icing management modules further includes a third icing management module on the port side and a fourth icing management module on the starboard side, wherein the third icing management module and the fourth icing management module are each spaced a second distance along the lateral direction from the longitudinal centerline greater than the first distance, and wherein the second segment of icing management module(s) includes at least the third icing management module and the fourth icing management module.
